(19) United States
(12) Patent Application Publication
(10) Pub. No.: US 2024/0181600 A1
(43) Pub. Date: Jun. 6, 2024

(54) Method for Cleaning Using Particles of a Solid Cryogenic Substance and Device for the Implementation Thereof

(71) Applicant: IRBIS TECHNOLOGY LLC, Moscow (RU)

(72) Inventor: Artur GIMADEEV, Kazan (RU)

(21) Appl. No.: 18/285,936

(22) PCT Filed: Mar. 15, 2022
(86) PCT No.: PCT/RU2022/050080

§ 371 Date: Oct. 6, 2023

(30) Foreign Application Priority Data
Apr. 9, 2021 (RU) 2021109877

(51) Int. Cl. B24C 3/06; B24C 1/00; B24C 5/02

(52) U.S. Cl. CPC B24C 3/06; B24C 1/003; B24C 5/02

(57) ABSTRACT

The invention relates to apparatuses for cleaning surfaces from contamination. The apparatus comprises a body, a shaft with a rotation axis, wherein such shaft is mounted to allow rotation in the body. The apparatus comprises a stationary cutter die secured to the body, and a flat throughput die secured to the body and placed below the stationary cutter die in a plane parallel to the plane of the stationary cutter die. The apparatus also comprises a rotating cutter die between the mounting plane of the upper stationary cutter die and the mounting plane of the flat throughput die, and is made to allow cutting the pellets of solid cryogenic substance in the plane of contact between the stationary cutter die and the rotating cutter die and/or in the plane of contact between the flat throughput die and the rotating cutter die. The invention allows improved performance of the dry ice blasting process.

### TECHNICAL FIELD

The claimed invention relates to mechanical engineering, in particular, to apparatus for cleaning surfaces from contamination and it can find application in various industrial sectors, such as automotive industry, aircraft industry, shipbuilding, nuclear power industry, foundry production, mechanical engineering, chemical industry, oil and gas industry, food industry, printing industry, light industry, power industry, and electronics. Namely, it can be used to clean pumps and tanks, oilfield equipment; remove various organic coatings and contaminants (varnishes, paints, oils, wax, mastic, mold, algae, glue, soot and other deposits); clean rust; remove graffiti from walls; clean electrical equipment, such as generators, electric motors, fans, compressors, radiators, printed circuit boards (PCBs); clean molds, casters, core boxes in the foundry industry; clean automotive assemblies at car washes; clean process equipment in the food industry; remove radioactive contaminants. The surface to be cleaned can be metal, glass, plastic, rubber, brick, etc. Also, dry ice can be used for cooling processes both during storage and transportation, and for blasting it on bulk (food additives) or viscous products (minced meat) to cool them during processing or to change their physical properties.

### PRIOR ART

Dry ice blasting is effectively used in a wide range of practical applications from slag removal to PCB cleaning. This cleaning method can be successfully used for in-service equipment without damaging or disassembling it, which significantly reduces downtime.

Unlike conventional toxic chemicals, high-pressure water, and abrasive cleaning, cryogenic cleaning uses dry ice particles in a high velocity air stream. At the same time, this does not pose process disadvantages associated with the recyclable materials and waste disposal. The physics behind cleaning with particles of solid cryogenic substance is as follows. The particles of solid cryogenic substance are accelerated in such medium as compressed air. In this regard, dry ice blasting is basically similar to sandblasting. Dry ice, which has a relatively low density, is used as a solid cryogenic substance, and the process relies on high velocity of particles to produce the required impact energy. When colliding with a surface, dry ice sublimates (evaporates) with an extremely fast heat transfer process between the ice pellets and the surface. No moisture is generated by the evaporation of dry ice. Within a few milliseconds, the gas then expands by hundreds of times compared to the volume of pelletized dry ice, causing a micro-explosion at the point of impact, which results in the destruction of contaminant. High temperature difference between the ice particles and the surface to be cleaned also causes a thermal shock that destroys the contaminating coating. This phenomenon is particularly evident when processing a non-metallic coating, such as paint coating on a metal substrate.

Blast cleaning systems have been around for decades.

Typically, the particles are fed into the transport gas stream and transported as trapped particles to a blast nozzle where the particles exit, traveling to a workpiece or other target.

An apparatus for dry ice blasting (US20190321942 published on Oct. 24, 2019) is known from the prior art. The apparatus comprises a mixer configured to selectively reduce the size of cryogenic particles from a corresponding initial size of each particle to a second size that is smaller than the specified size, wherein the crusher comprises at least one first roller rotating about the first axis, each of which comprises at least one first roller containing a corresponding first peripheral surface, wherein each corresponding first peripheral surface collectively contains multiple first raised ridges; and at least one second roller rotating about a second axis, each of which comprises at least one second roller containing a corresponding second peripheral surface, wherein each corresponding second peripheral surface collectively comprises multiple second protruding ridges; a gap formed between each corresponding first peripheral surface and each corresponding second peripheral surface.

The disadvantage of this technical solution is the use of pellets of no more than 3 mm, and the use of large pellets of 16-30 mm already poses a problem. The reasons are explained in the technology book “Crushing in the Chemical Industry” by P. M. Sidenko, which indicates that the size of pieces of crushed material should be about 20 times smaller than the diameter of the rolls to ensure that the pieces of crushed material are dragged in by the friction between the rolls. In practice, the largest diameter of used pieces is usually 20-25 times smaller than the diameter of the rolls. The size of the crushed product pieces ranges from 10 mm to 5 mm, but it is no less than 2 mm-3 mm.” Therefore, the use of the same roller crusher to crush pellets of 16 mm-30 mm would require rollers with a diameter of 320 mm-400 mm, and there are always two rollers, which is already comparable to the size of conventional dry ice blasting machines.

Also, in the known apparatus, the cryogenic particles are crushed by squeezing them between rollers. Such crushing produces particles of various sizes and shapes. Also, the known apparatus uses an additional upper dispenser and electrical control system, which makes the system less reliable.

In the disclosed analogs, the moving elements involved in the physical impact on the pellets to crush them, are in contact with the pellets only. In the technical solution claimed in the present invention, the cutter rests on the die and rubs against it, the cutter is made of a strong wear-resistant technical plastic, which allows to contact both the die and the upper cutter flange. The contact surfaces of the die and flange are smooth to prevent abrasion of the cutter plastic. In addition, as the claimed invention allows to replace the crushing die (when there are no pellets in the hopper), it does not require large and complex crushing adjustment systems as in the technical solution known from US20190321942A1.

Also, unlike U.S. Ser. No. 00/602,05326, the claimed technical solution allows to crush pellets under their own weight by using gravity. The known solution requires an actuator to press the pellets down.

Unlike the disclosed analogs, the technical solution according to the present invention allows to crush pellets ranging in size from 3 mm to 30 mm, or even pieces of dry ice blocks. Also, the claimed invention can be used to obtain dry ice particles of the desired fraction for cooling processes.

### SUMMARY OF THE INVENTION

The objective addressed by the claimed group of inventions is to create a reliable and high-performance apparatus for dry ice blasting, wherein both large and smaller dry ice pellets can be loaded into the hopper of the unit. The embodiment of the technical solution according to the present invention allows the unit to use dry ice pellets that are less than 1.6 mm in size, as well as the dry ice pellets that are larger than 1.6 mm, in particular, the pellets of 3 mm, 6 mm, 9 mm, 16 mm, 20 mm and even 30 mm. There is no size limitation, but just the requirement to use cutters and dies of a larger diameter.

The technical result of the claimed group of inventions consists in crushing dry ice pellets to make them uniform in terms of shape and size of particles of 1 mm-1.5 mm, which allows to raise the density of dry ice particles in the compressed air blast and to increase their velocity due to lower mass, which in combination produces a more aggressive and effective cleaning for the majority of contaminants; in addition, the technical result of the claimed group of inventions also consists in reducing the time and labor intensity, and improving the reliability of procedure for changing the throughput die, in contrast to the variant when it would be necessary to remove the crusher unit from the hopper after disassembling the entire unit, which would increase the time for changing the die, and pose a risk of incorrect re-assembly of the crusher unit.

The technical result of the claimed group of inventions is achieved by the fact that the apparatus for cleaning with solid cryogenic substance comprises a hopper to store pellets of solid cryogenic substance; a crusher of pellets of solid cryogenic substance made to allow cutting the said pellets of solid cryogenic substance; a feeding unit made to allow feeding crushed pellets of solid cryogenic substance into the compressed air stream; a nozzle for feeding crushed pellets of solid cryogenic substance to the object to be cleaned; and a pneumatic line for transporting crushed pellets of solid cryogenic substance from the said feeding unit to the said nozzle; wherein the said crusher comprises the body of the crusher; stationary cutter die made with at least one stationary cutter and secured to the said body of the crusher, rotating cutter die made to allow the rotation about its axis and made in the form of at least one cutter with a cutting edge; and a flat throughput die arranged in the said body of the crusher in a plane that is parallel to the plane of the rotating cutter die, wherein the said rotating cutter die is located between the plane of the unit of the said stationary cutter die and the plane of the unit of the said flat throughput die and is parallel to the plane of the said stationary cutter die, wherein the stationary cutter die is located at a distance relative to the flat throughput die that determines the size of the crushed pellets of solid cryogenic substance, and the flat throughput die is made with multiple through holes that are made to allow holding the pellets of solid cryogenic substance with the size exceeding the size specified for cleaning, when cutting the said pellets in the plane defined by the contact between the flat throughput die and the rotating cutter die; and to allow the subsequent throughput of crushed pellets of solid cryogenic substance with the size specified for cleaning.

In a particular embodiment of the claimed technical solution, the crusher is made to allow cutting pellets of solid cryogenic substance in the plane defined by the contact between the stationary cutter die and the rotating cutter die, and/or in the plane defined by the contact between the flat throughput die and the rotating cutter die.

In a particular embodiment of the claimed technical solution, the crusher is made so that the flat throughput die is made to allow lateral installation and removal from the body of the crusher without disassembling the body, rotating cutter die and stationary cutter die.

In a particular embodiment of the claimed technical solution, the through holes of the flat throughput die are slit-shaped and radially divergent.

In a particular embodiment of the claimed technical solution, the through holes in the flat throughput die are made in the form of a circle or rectangle, or triangle, or oval, or complex curved shape.

In a particular embodiment of the claimed technical solution, the rotating cutter die is in the form of at least two cutters with cutting edges radially divergent and connected to each other by an outer rim.

In a particular embodiment of the claimed technical solution, the stationary cutter die is made in the form of at least two stationary cutters with cutting edges radially divergent and connected to each other by an outer rim, which strengthens the cutters when they are bent in the cutting planes, whereby the cutters can be made narrower, which creates a greater clearance for pellets to enter the cutting planes for their subsequent cutting, which generally improves the performance of the crusher.

In a particular embodiment of the claimed technical solution, the rotating cutter die is made of a wear-resistant polymer that retains its strength at dry ice temperatures.

In a particular embodiment of the claimed technical solution, the surface of the flat throughput die that is in contact with the rotating cutter die and the surface of the upper stationary cutter die that is in contact with the rotating cutter die are smooth.

In a particular embodiment of the claimed technical solution, the rotating cutter die is mounted on a shaft, which is mounted to allow the rotation in the body and is driven by a shaft rotation engine made in the form of an electric motor with a gearbox.

In a particular embodiment of the claimed technical solution, the rotating cutter die is made with meshing teeth arranged circumferentially, wherein the rotating cutter die is driven in rotational motion about its axis by engagement with a gear transmission through the said meshing teeth or by engagement with a chain transmission from an external drive through the said meshing teeth.

In a particular embodiment of the claimed technical solution, the body of the crusher is made with a hollow inner cylindrical part, wherein the side surface of the cylindrical part of the body of the crusher is made with an outlet opening for crushed pellets of solid cryogenic substance.

In a particular embodiment of the claimed technical solution, additionally, the body of the crusher has a rotational impeller mounted under the flat throughput die for rejecting the said crushed pellets of solid cryogenic substance from the said body.

In a particular embodiment of the claimed technical solution, the target size of the crushed pellets of solid cryogenic substance obtained after passing through the flat throughput die is within the range of 0.1 mm to 6 mm.

In a particular embodiment of the claimed technical solution, the physical geometric distance between the stationary cutter die and the flat throughput die is within the range of 1 mm to 10 mm.

In a particular embodiment of the claimed technical solution, the thickness of the rotating cutter die is within the range of 1 mm to 10 mm, but no less than the physical geometric distance between the stationary cutter die and the flat throughput die.

The technical result of the claimed group of inventions is also achieved by the fact that a method for cleaning with solid cryogenic substance implemented with the claimed apparatus includes the steps where the pellets of solid cryogenic substance are loaded into the hopper for storing the pellets of solid cryogenic substance; the compressed air is fed into the feeding unit; the pellets of solid cryogenic substance are fed into the crusher; the pellets of solid cryogenic substance are held in through holes of the flat throughput die; the pellets of solid cryogenic substance are cut in the plane defined by the contact of non-moving flat throughput die with the rotating cutter die; the crushed pellets of the size specified for cleaning are let to pass through the flat throughput die; the crushed pellets of the solid cryogenic substance, that have the size specified for cleaning, are transported into the compressed air stream in the feedingunit, the crushed pellets of solid cryogenic substance are transported over the pneumatic line from the feeding unit to the nozzle; the object to be cleaned is cleaned by blasting it through the nozzle with a mixture of compressed air and crushed pellets of solid cryogenic substance.

In a particular embodiment of the claimed technical solution, the pellets of solid cryogenic substance are additionally cut in the plane defined by the contact between the stationary cutter die and the rotating cutter die.

In a particular embodiment of the claimed technical solution, the hopper is loaded with the pellets of solid cryogenic substance that have a diameter of 1 mm to 30 mm;

In a particular embodiment of the claimed technical solution, the pellets of solid cryogenic substance are transported from the hopper to the crusher under their own weight.

### BRIEF DESCRIPTION OF THE DRAWINGS

The details, features, and advantages of this invention can be seen below in the description of embodiments of the claimed technical solution provided along with the drawings that show the following:

FIG. 1 shows the mobile unit for dry ice blasting;

FIG. 2 shows a general view of the mobile unit for dry ice blasting without side doors and front cover;

FIG. 3 shows the unit view without the bent load-bearing frame and top panel and hatch;

FIG. 4 shows the hopper with the crusher and the pellet feeding unit;

FIG. 5 shows a view of the hopper with integrated crusher;

FIG. 6 shows a view of the crusher;

FIG. 7 shows the process of removing the crushing die from the crusher;

FIG. 8 shows the process of removing the crusher from the lower part of the hopper;

FIG. 9 shows a view of the crusher as a stand-alone assembly;

FIG. 10 shows a view of the crusher with removed upper cutter flange, circular frame for securing the die, distancing frame;

FIG. 11 shows a view of the crusher with rotating cutter removed from the shaft;

FIG. 12 shows a view of the crusher with removed die, cutter, and die support;

FIG. 13 shows a view of the crusher with removed shaft, impeller, ring, and the body;

FIG. 14 shows the operating principle of crushing;

FIG. 15 shows an embodiment of rotating cutter die with meshing teeth;

FIG. 16 shows the process of crushing the pellets by scraping them with cutters, which results in obtaining dust and fine flakes that do not have sufficient mass for aggressive cleaning and can be used to clean light contaminants only. The apparatus disclosed in US20130203325A1 relates to this method;

FIG. 17 shows the process of crushing the pellets by squeezing them. This process produces pellets of different sizes and leads to their excessive squeezing, which may result in the greater amounts of dry ice dust. The apparatus disclosed in US20190321942A1 relates to this method;

FIG. 18 shows the process of cutting the pellets, which results in obtaining crushed particles with pre-determined size, because a sieve (throughput die) installed at the bottom either lets a particle through or holds it for re-cutting.

The numbers in the figures indicate the following structural elements:

1—hopper grid; 2—hopper suspension; 3—hopper; 4—crusher connected to the hopper; 5—pellet feeding unit; 6—quick coupler for connecting the blast hose; 7—filter for removing moisture droplets in compressed air; 8—compressed air reducer; 9—flat throughput die with narrow radial through holes; 10—hopper flange; 11—outlet pipe for crushed particles; 12—gearbox; 13—electric motor; 14—lower part of the hopper; 15—pellet of solid cryogenic substance; 16—manually operated die clamp; 17—narrow radial through holes; 18—stationary cutter die acting as a flange; 19—circular frame for distancing the stationary cutter die relative to the rotating cutter; 20—additional distancing frame; 21—rotating cutter die; 22—support for flat throughput die; 23—impeller for rejecting pellets to the perimeter of the inner cylindrical part of the body; 24—gearbox shaft for transmitting torque to the impeller and the rotating cutter; 25—body of the crusher; 26—space between the cutters; 27—meshing teeth.

### SUMMARY OF INVENTION

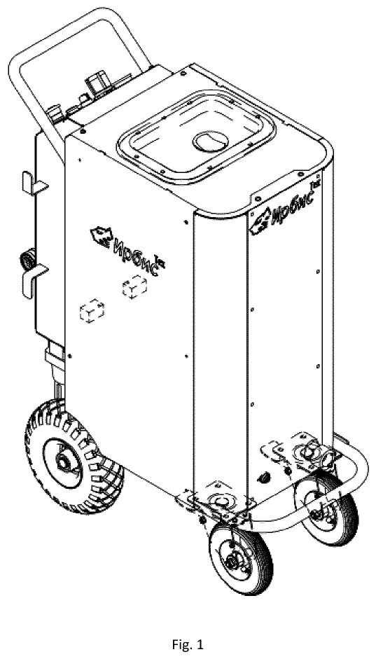

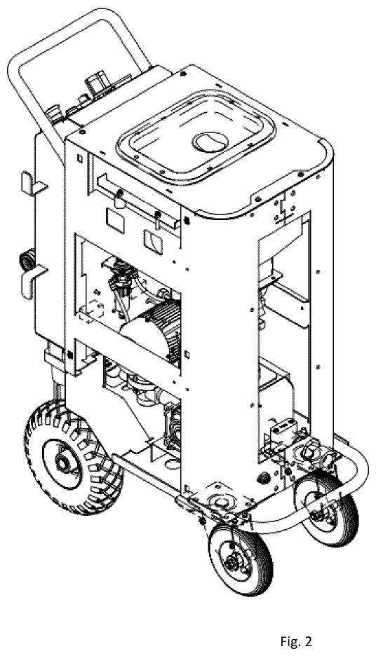

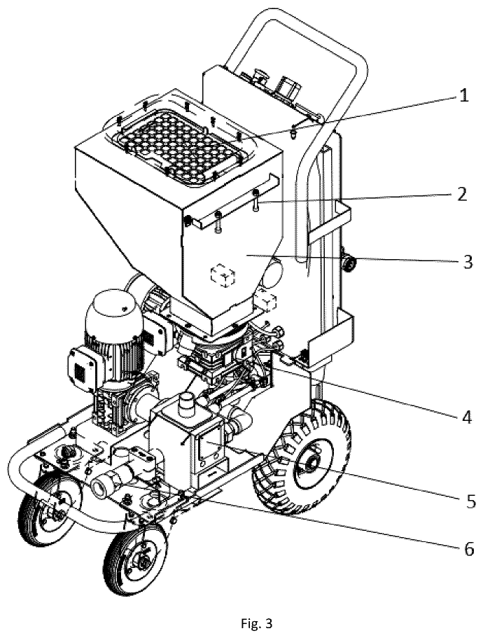

In general terms, the apparatus for cleaning with particles of solid cryogenic substance can be made as a stationary or mobile unit. An embodiment of such mobile unit is shown on FIG. 1-FIG. 3. The description below shows an embodiment of such mobile unit.

The mobile apparatus is made on a frame mounted on wheels. Inside, in the upper part of the frame, there is a hopper (3) for storing pellets of solid cryogenic substance and pellet feeding unit (5). The pellet feeding unit (5) is connected to the hopper (3) by means of pipes. The hopper (3) is secured on the frame by means of suspensions (2).

The apparatus is made to allows feeding the compressed air into the pellet feeding unit (5). To do this, the apparatus has pipes located within the apparatus. The apparatus has a nipple for connecting a compressed air source. The nipple is connected to the filter (7) by means of a pipe. The filter (7) is required to filter and remove moisture droplets from the compressed air. The pipes and the filter (7) have a quick coupler for removing the filter. To regulate the pressure of the incoming compressed air in the pellet feeding unit (5), the apparatus has compressed air reducer (8), which ensures the cleaning aggressiveness regulation. The apparatus also has a pneumatic quick coupler (6) for connecting the blast hose. The quick coupler (6) is installed at the outlet of the feeding unit (5) for the pellets of solid cryogenic substance.

The pellets of solid cryogenic substance are loaded into the hopper (3) through the hopper grid (1). Under their own weight, the pellets of solid cryogenic substance are transported from the hopper (3) to the crusher (4) connected to the bottom of the hopper (3). Through the pipe connected to the outlet pipe (11) for crushed particles of solid cryogenic substance, the crushed particles of solid cryogenic substance are fed from the crusher (4) to the feeding unit (5). Compressed air is also connected to the feeding unit (5). In the feeding unit (5), the particles of solid cryogenic substance are mixed with compressed air, and the mixture is then fed to the nozzle through the blast hose. In the nozzle, the pellets are accelerated by the rapid stream of air and are blasted out of the slit.

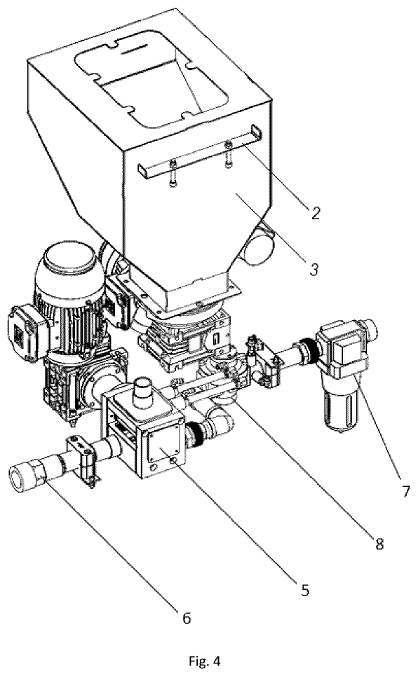

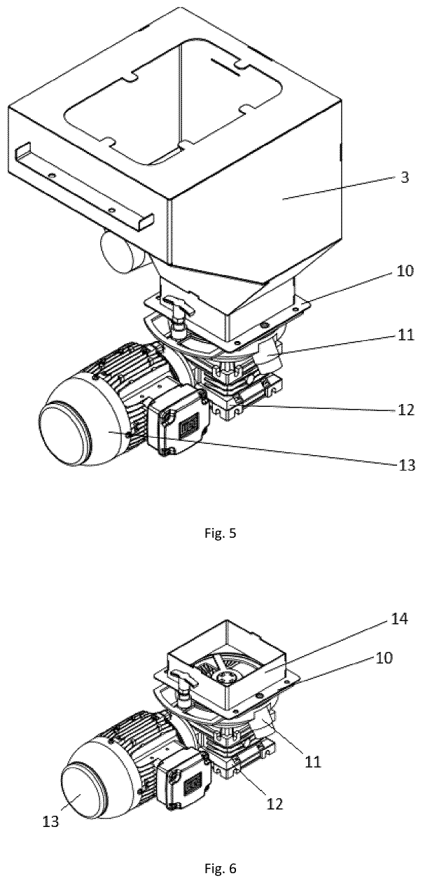

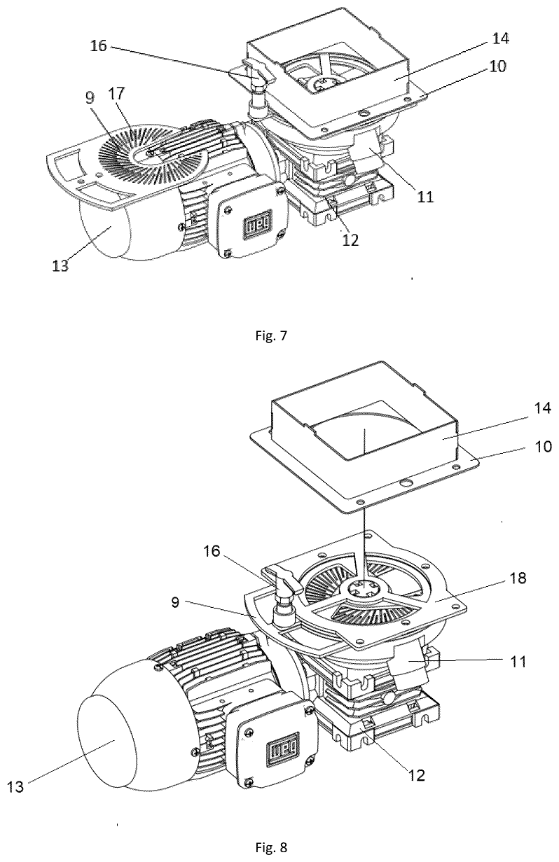

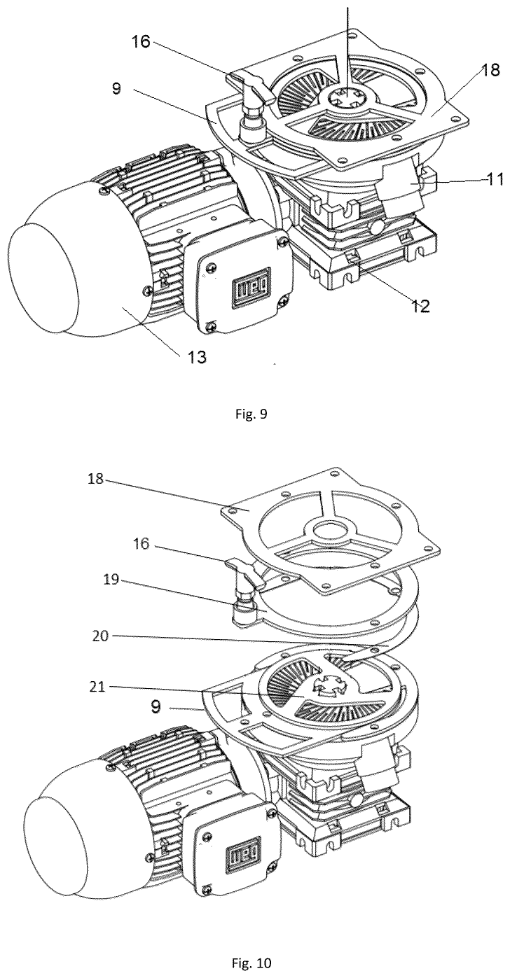

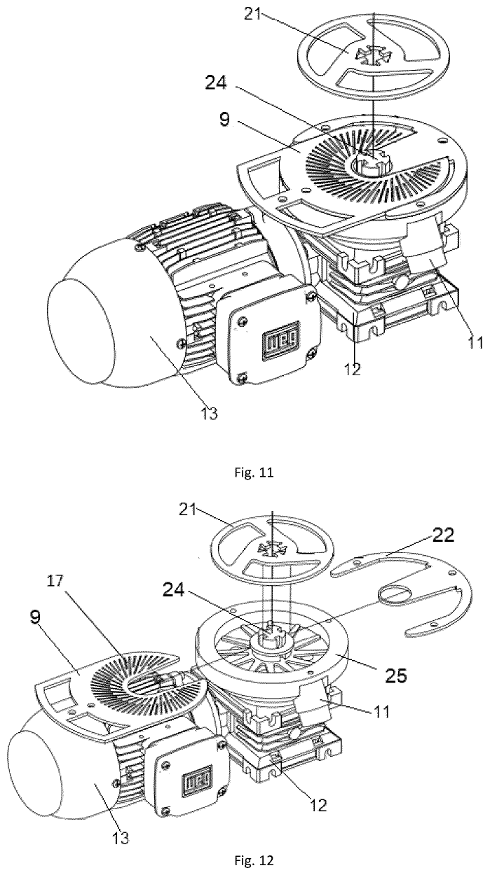

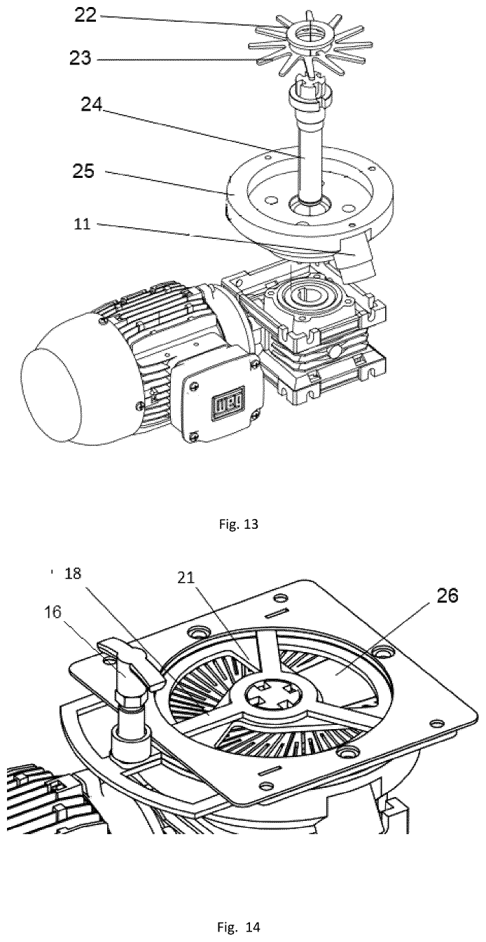

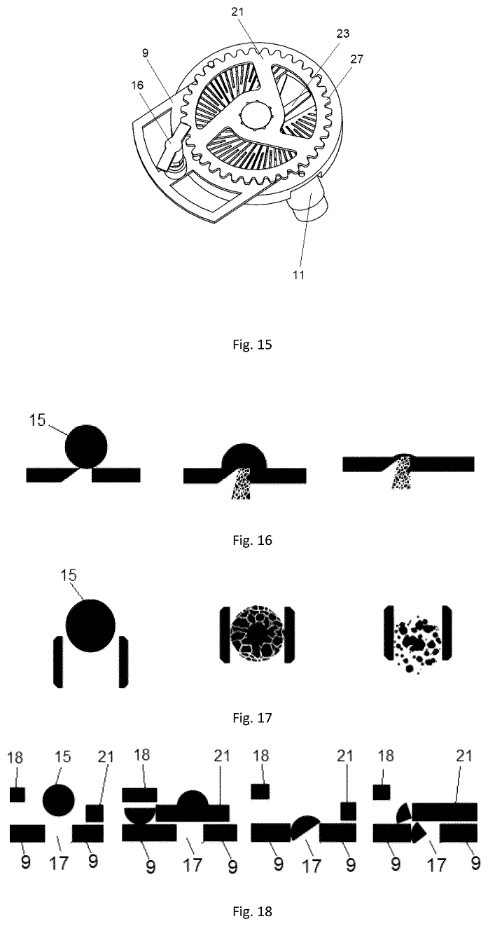

The following is a detailed description of the pellet crusher (4) with reference to FIG. 4-FIG. 15. The design of the crusher (4) is the subject matter of the present invention.

The crusher (4) is attached to the lower part (14) of the hopper (3) with the hopper flange (10) through the stationary cutter die (18). The stationary cutter die (18) additionally acts as a flange with holes for a hermetically tight connection to the hopper flange.

The crusher comprises a body (25). The body (25) is formed by the lower and side surfaces and is made with a hollow inner cylindrical part and is provided with an outlet pipe (11) to let crushed particles of solid cryogenic substance out of the crusher, wherein such pipe is made in the side surface of the cylindrical part of the body (25). The body (25) is connected to a gearbox, the shaft (24) of which is extended inside the hollow part of the body of the crusher, wherein the shaft (24) is made to allow transmitting torque to the impeller (23) and the rotating cutter die (21).

An impeller (23), which is designed for rejecting the crushed particles of solid cryogenic substance towards the perimeter of the hollow inner cylindrical part of the body and for rejecting them, in the process of its rotation, to the outlet pipe (11) for crushed particles of solid cryogenic substance, is located within the body (25) on the gearbox shaft (24).

A support (22) for a flat throughput die (9) is located above the impeller (2). The support is secured on the butt end of the side surface of the body (25). The support (23) is made with an opening for the shaft (24). The shaft (24) does not interact with the support (23). The support (23) for flat throughput die (9) serves to limit the movement of flat throughput die (9) during its installation and to form a full circle for the die (to close the die circle) so that the pellets do not fall through and are always above the die. A die (9) with an incomplete circle of closing the through passage of the crusher is located above the support (22).

A flat throughput die (9) does not interact with the shaft (24) and is made as a flat disk with a notch from the edge of the disk to the shaft (24). This notch is required for the lateral installation and lateral removal of the flat throughput die, that is installed between the upper stationary cutter die and the rotating cutter die, from the body of the crusher. The lateral installation and lateral removal of the flat throughput die is required to ensure the possibility of removing the flat throughput die from the crusher without disassembling the crusher. In the crusher, a flat throughput die (9) is secured by means of a manually operated die clamp (16).

The flat throughput die is provided with an element which can be used to remove the flat throughput die from the crusher. In an embodiment of the claimed technical solution, the said element is made in the form of a handle, or it is made in the form of an arc or holes.

The flat throughput die (9) is made with multiple radial slotted through holes (17). The through holes (17) made in the flat throughput die (9) serve to let through the particles of smaller fractions of solid cryogenic substance and to hold the particles of larger fractions of solid cryogenic substance for re-cutting them with the cutters of the rotating cutter die (21).

The through holes (17) made in the flat throughput die (9) can be of different shapes, such as circle, rectangle, triangle, oval or complex curvilinear shapes, where the main factor is to ensure a distance between the opposite edges of the holes that let through only the crushed particle of solid cryogenic substance with certain dimensions, i.e. the holes play the role of filtering the particles by their size.

Of course, it would be impossible to crush 100% of filtered particles of solid cryogenic substance to a certain size in one flat filtration step, because, for example, an oblong pellet of solid cryogenic substance of cylindrical shape with a diameter of 3 mm can pass through a slit-shaped hole with a slit width of 3.5 mm or lengthwise through a circular hole with a diameter of 3.5 mm. The same applies to uneven particles of solid cryogenic substance, where some particles of solid cryogenic substance that have larger size can pass through the holes (17), but this would be an insignificant part of the whole stream.

When using large pellets, which are larger than the gap between the stationary cutter die and the throughput die, the cutting takes place in two steps (in two planes)—in the plane defined by the contact between the stationary cutter die and the rotating cutter die, and in the plane defined by the contact between the flat throughput die and the rotating cutter die. If the size of the pellets is smaller than the gap, then most of the cutting takes place only in the plane defined by the contact between the flat throughput die and the rotating cutter die. The holes can have any geometry, but their main function is to hold particles/pellets when cutting on the lower plane and to let through the particles with a size that is appropriate for cleaning.

To improve the efficiency of crushing and filtration, the crusher additionally comprises a second rotating cutter mounted under the flat throughput die (17) and a second flat throughput die mounted under the second rotating cutter.

A rotating cutter die (21) is located above the flat throughput die (9) on the shaft (24).

In an embodiment of the claimed technical solution, the rotating cutter die (21) is made in the form of at least one cutter with a cutting edge.

In an embodiment of the claimed technical solution, the rotating cutter die (21) is made in the form of at least two cutters with a cutting edge wherein such cutters are connected to each other circumferentially by an outer rim.

In the preferred embodiment of the claimed technical solution, the rotating cutter die is made in the form of three radially divergent cutters with cutting edges, wherein such cutters are connected to each other circumferentially by an outer rim.

In an embodiment of the claimed technical solution, the physical geometric distance between the stationary cutter die and the flat throughput die is within the range of 1 mm to 10 mm.

In a particular embodiment of the claimed technical solution, the thickness of the rotating cutter die is within the range of 1 mm to 10 mm, but no less than the physical geometric distance between the stationary cutter die and the flat throughput die.

The connection of the cutters in the rotating cutter die (21) circumferentially by an outer rim is required to increase the strength of the rotating cutter die.

An additional distancing frame (20) and circular frame (19) are placed above the rotating cutter die (21) to distance the stationary cutter die (18) from the rotating cutter die. Both frames (19 and 20) are firmly secured on the butt ends of the side surface of the body (25). The additional distancing frame (20) is required to ensure that the rotating cutter die (21) sits freely between the stationary cutter die (18) and the flat throughput die (9). A stationary cutter die (18) is placed above the circular frame (19). A flat throughput die (9) is located from the rotating cutter die (18) at a distance that determines the maximum size of the cutting fraction.

In addition to its function of securing the crusher (4) to the flange (10), the stationary cutter die (18) also has a function of stationary cutters. The use of a stationary cutter die allows to perform preliminary crushing/cutting of large pellets or thin long pellets, which will then result in a higher throughput of the crusher.

In an embodiment of the claimed technical solution, the stationary cutter die is made in the form of two stationary cutters with cutting edges radially divergent and connected to each other by an outer rim.

In an embodiment of the claimed technical solution, the stationary cutter die is made in the form of three stationary cutters with cutting edges radially divergent and connected to each other circumferentially by an outer rim.

The connection of the cutters with cutting edge circumferentially by an outer rim is required to increase the strength of the stationary cutter die. The outer rim strengthens the cutters when they are bent in the cutting planes, whereby the cutters can be made narrower, which creates a greater clearance for pellets to enter the cutting planes for their subsequent cutting, which generally improves the performance of the crusher.

The hopper (3) is fed with pellets of solid cryogenic substance of 1 mm to 30 mm. Next, the butt end of the pellets of solid cryogenic substance or the entire pellet of solid cryogenic substance falls between the cutters of the rotary throughput die (21) with cutting edges and touches the flat throughput die (9). Next, the cutters of the rotating throughput die (21) start pulling the pellets through to one of the stationary cutters of the stationary cutter die (18) of the crusher.

After that, the crushed particles of solid cryogenic substance, which turned out to be smaller than the width of through holes (17) made in flat throughput die (9), fall through these holes and get into the body (25) with impeller (23), which ejects them from the crusher's body through the pipe (11).

The particles of solid cryogenic substance, which are larger than the width of the through holes (17) in the flat throughput die (9), get stuck in these holes and then the cutters of the rotating die (21) cut them again, and this is facilitated either by the thrust of the particles against the stationary cutter die (18) or by the pressure of pellets of solid cryogenic substance fed from above from by the hopper (3).

In the claimed technical solution, the rotating cutter die (21) lies on and rubs against the flat throughput die (9). The rotating cutter die (21) is made of a strong wear-resistant technical plastic, which allows the embodiments where it can contact both the flat throughput die and the stationary cutter die (18). The contact surfaces of the flat throughput die and the stationary cutter die are made smooth to prevent abrasion of the cutter plastic.

The design of the claimed technical solution enables the achievement of the following advantages:
possibility of using cylindrical pellets of solid cryogenic substance with diameter from 1 mm to 30 mm;
crushing based on the cutting principle yields more homogeneous size of particles of solid cryogenic substance;
pellets of solid cryogenic substance are crushed under their own weight without any additional devices, which increases the reliability of the system;
integrated die ensures that the size of particles of solid cryogenic substance is controlled, and the particles of larger sizes will not pass through;
easy method for replacing the die, with no fine tuning or settings required.

1. An apparatus for cleaning with solid cryogenic substance comprising:
a hopper to store pellets of solid cryogenic substance;
a crusher for pellets of solid cryogenic substance made to allow cutting the said pellets of solid cryogenic substance;
a feeding unit made to allow transporting crushed pellets of solid cryogenic substance into compressed air stream;
a nozzle to blast crushed pellets of solid cryogenic substance on the object to be cleaned; and
a pneumatic line to transport crushed pellets of solid cryogenic substance from the said feeding unit to the said nozzle;
wherein the said crusher comprises:
a body of the crusher;
a stationary cutter die made with at least one stationary cutter and secured on the said body of the crusher,
a rotating cutter die made to allow the rotation about its axis and made in the form of at least one cutter with cutting edge;
and a flat throughput die located in the said body of the crusher in the plane that is parallel to the plane of the rotating cutter die;
wherein the said rotating cutter die is located between the mounting plane of the said stationary cutter die and the mounting plane of the said flat throughput die, and is parallel to the plane of the said stationary cutter die,
wherein the stationary cutter die is located relative to the flat throughput die at a distance that determines the size of crushed pellets of solid cryogenic substance,
a flat throughput die made with multiple through holes made to allow holding the pellets of solid cryogenic substance with a size that exceeds the one specified for cleaning, when cutting the said pellets in the plane defined by the contact between the flat throughput die and the rotating cutter die and subsequently letting through the crushed pellets of solid cryogenic substance with the size specified for cleaning.

2. The apparatus according to claim 1 wherein the crusher is made to allow cutting the pellets of solid cryogenic substance in the plane defined by the contact between the stationary cutter die and the rotating cutter die, and/or in the plane defined by the contact between the flat throughput die and the rotating cutter die.

3. The apparatus according to claim 1 characterized in that wherein the crusher is made so that the flat throughput die is made to allow lateral installation and removal from the body of the crusher without disassembling the body, rotating cutter die and stationary cutter die.

4. The apparatus according to claim 1, wherein the through holes of the flat throughput die are slit-shaped and radially divergent.

5. The apparatus according to claim 1 wherein the through holes in the flat throughput die are made in the form of a circle or rectangle, or triangle, or oval, or complex curved shape.

6. The apparatus according to claim 1 wherein the rotating cutter die is in the form of at least two cutters with cutting edges radially divergent and connected to each other by an outer rim.

7. The apparatus according to claim 1 wherein the stationary cutter die is made in the form of two stationary cutters with cutting edges radially divergent and connected to each other by an outer rim.

8. The apparatus according to claim 1 wherein the rotating cutter die is made from a strong wear-resistant material.

9. The apparatus according to claim 1 wherein the surface of the flat throughput die, that is in contact with the rotating cutter die, and the surface of the upper stationary cutter die, that is in contact with the rotating cutter die, are smooth.

10. The apparatus according to claim 1 wherein the rotating cutter die is mounted on a shaft, which is mounted to allow the rotation in the body and is driven by a shaft rotation drive made in the form of an electric motor with a gearbox.

11. The apparatus according to claim 1 wherein the rotating cutter die is made with meshing teeth arranged circumferentially, wherein the rotating cutter die is driven in rotational motion about its axis by engagement with a gear transmission through the said meshing teeth or by engagement with a chain transmission from an external drive through the said meshing teeth.

12. The apparatus according to claim 1 wherein the body of the crusher is made with a hollow inner cylindrical part, wherein the side surface of the cylindrical part of the body of the crusher is made with an outlet opening for crushed pellets of solid cryogenic substance.

13. The apparatus according to claim 1 wherein, additionally, the body of the crusher has a rotational impeller mounted under the flat throughput die for rejecting the said crushed pellets of solid cryogenic substance from the said body.

14. The apparatus according to claim 1 wherein the target size of the crushed pellets of solid cryogenic substance obtained after passing through the flat throughput die is within the range of 0.1 mm to 6 mm.

15. A method for cleaning with solid cryogenic substance by using an apparatus according to claim 1, including the steps, wherein:
pellets of solid cryogenic substance are loaded into the hopper for storing pellets of solid cryogenic substance;
compressed air is fed into the feeding unit;
pellets of solid cryogenic substance are fed into the crusher;
pellets of solid cryogenic substance are held in through holes of the flat throughput die;
pellets of solid cryogenic substance are cut in the plane defined by the contact between the flat throughput die and the rotating cutter die;
crushed pellets of the size specified for cleaning are let through the flat throughput die;
crushed pellets of solid cryogenic substance of the size specified for cleaning are transported to compressed air stream in the feeding unit,
crushed pellets of solid cryogenic substance are transported over a pneumatic line from the feeding unit to the nozzle;
object to be cleaned is cleaned by blasting it with a mixture of compressed air and the crushed pellets of solid cryogenic substance through the nozzle.

16. The method according to claim 15 wherein the pellets of solid cryogenic substance are additionally cut in the plane defined by the contact between the stationary cutter die and the rotating cutter die.

17. The method according to claim 15 wherein the hopper is loaded with pellets of solid cryogenic substance that have a diameter of 1 mm to 30 mm;

18. The method according to claim 15 wherein the pellets of solid cryogenic substance are transported from the hopper to the crusher under their own weight.
